(19) United States
(12) Patent Application Publication
(10) Pub. No.: US 2004/0085992 A1
(43) Pub. Date: May 6, 2004

(54) Shared-medium contention algorithm exhibiting fairness

(76) Inventor: Maarten Menzo Wentink, Utrecht (NL)

Correspondence Address: DEMONT & BREYER, LLC, SUITE 250, 100 COMMONS WAY, HOLMDEL, NJ, 07733, US

(21) Appl. No.: 10/421,230

(22) Filed: Apr. 23, 2003

Related U.S. Application Data
(60) Provisional application No. 60/423,813, filed on Nov. 5, 2002.

(51) Int. Cl. H04L 12/413

(52) U.S. Cl. 370/445; 370/338

(57) ABSTRACT

A technique is disclosed for maintaining fairness in scheduling order while communicating multiple streams on a shared-communications medium. Simulations have shown that the scheduling order of when stations transmit is of great importance. Typically, the scheduling order of multiple streams of message traffic on a shared-communications medium is unfair, at least in the short term. Streaming applications, however, demand fairness in short term scheduling. Otherwise, the intermediate delays would be unacceptably uneven. To address the delay problems associated with multiple streams on a shared-communications medium, each station transmits a portion of a coordinated flow. After transmitting the portion, the station self-imposes a restriction interval, during which time, the station cannot contend again for the purpose of transmitting the next portion of the coordinated flow.

### CROSS-REFERENCE TO RELATED APPLICATIONS

This application claims the benefit of U.S. Provisional Patent Application Ser. No.: 60/423,813, entitled “Limited Contender Queue,” filed on Nov. 5, 2002 (Attorney Docket: 680-036us), which is incorporated by reference.

### FIELD OF THE INVENTION

The present invention relates to telecommunications in general, and, more particularly, to a communications station that is transmitting information with a high access priority.

### BACKGROUND OF THE INVENTION

FIG. 1 depicts a schematic diagram of telecommunications system 100 in the prior art, which transmits signals between communication stations 101-1 through 101-P, wherein P is a positive integer, over shared-communications medium 102. Stations 101-1 through 101-P and shared-communications medium 102 constitute a local area network (LAN).

A local area network is commonly used to connect computing devices (i.e., stations) in various locations (e.g., company offices, etc.) to exchange information and share resources (e.g., printers, mail servers, etc.). Transmission between the stations can occur across wires or over the air, as in a wireless local area network. Local area networks are typically governed by certain standards. IEEE 802.11 is an example of a standard that governs a wireless local area network.

Stations 101-1 through 101-P are computing devices capable of communicating with each other using wireless network interfaces and, together, constitute a basic service set (which is also called a “BSS”) in an 802.11-based network. A basic service set can be regarded as a building block for an 802.11-based network. Station 101-2 enables stations 101-1 through 101-P to communicate with other communications networks outside of the BSS and is appropriately referred to as an “access point.”

FIG. 2 depicts stations 201 and 202 in the prior art. They communicate with each other through dedicated transmission channels 203 and 204. Because stations 201 and 202 communication via dedicated transmission channels 203 and 204, stations 201 and 202 need not be concerned with sharing transmission resources. In contrast, stations 101-1 through 101-P have to share the transmission medium (e.g., a cable, the airwaves, etc.) that ties them all together, namely shared-communications medium 102, in the same manner that users need to share a telephone party line. Consequently, stations 101-1 through 101-P have to follow rules (or “protocols”) that govern, among other things, when and for how long at a time they each can use shared-communications medium 102. Stations 101-1 through 101-P gain access to shared-communications medium 102 by following the established protocols of IEEE 802.11. Depending on the application, stations 101-1 through 101-P can have varying degrees of success in transmitting information to each other using a shared-communications medium.

### SUMMARY OF THE INVENTION

Simulations with many types of distributed, shared access mechanisms have shown that the scheduling order or “queue discipline” of when stations transmit is of great importance. For instance, the 802.11 Distributed Coordination Function is not a guarantee for any scheduling order, due to the random postbackoff that it defines. Long time, unfairness could exist for any given CWmin and CWmax value used in the randomizing process. Examples of fair and unfair scheduling sequences for three streams of traffic are:

Fair scheduling order: 1-2-3-1-2-3-1-2-3-1-2-3-1-2-3-1-etc.

Unfair scheduling order: 1-1-1-2-3-1-1-1-2-3-3-3-3-3-3-etc.,

wherein each number (i.e., 1, 2, 3) represents traffic from a given stream of the three.

Typically, the latter sequence represents shared-communications medium activity involving the three streams of message traffic. The latter sequence might also be fair over the long term, but streaming applications demand short term scheduling fairness. Otherwise, the intermediate delays would be unacceptably uneven and buffer overflows could occur. Short term scheduling fairness is crucial in keeping the delays acceptable for all streams at any time. This is particularly true for devices transmitting real-time signals, such as audio and video streams. It is crucial that the signals are crisp and uninterrupted in real-time applications.

The present invention solves the problem where multiple stations seek to communicate streams (i.e., flows) with each other while maintaining fairness in scheduling. In some embodiments of the present invention, each station transmits a portion of a coordinated flow after contending for access to a shared-communications medium. After transmitting the portion, the station self-imposes a restriction interval, during which time, the station cannot contend again for the shared-communications medium to transmit the next portion of the coordinated flow. The restriction interval selected staggers the contentions of the individual stations into a scheduling order exhibiting fairness. In accordance with the illustrative embodiment, when the station is again permitted to transmit, it then waits a shortened backoff interval that ensures that the station wins contention for the channel when it needs to.

The illustrative embodiment of the present invention comprises contending for access to a shared-communications medium; transmitting a first portion of a flow into the shared-communications medium, wherein the flow has a maximum length of T milliseconds; and waiting for at least T*(N−1) milliseconds before again contending for access to the shared-communications medium to transmit a second portion of the flow, wherein N is a positive integer equal to the number of coordinated flows permitted concurrently on the shared-communications medium.

### BRIEF DESCRIPTION OF THE DRAWINGS

FIG. 1 depicts a schematic diagram of telecommunications system 100 in the prior art.

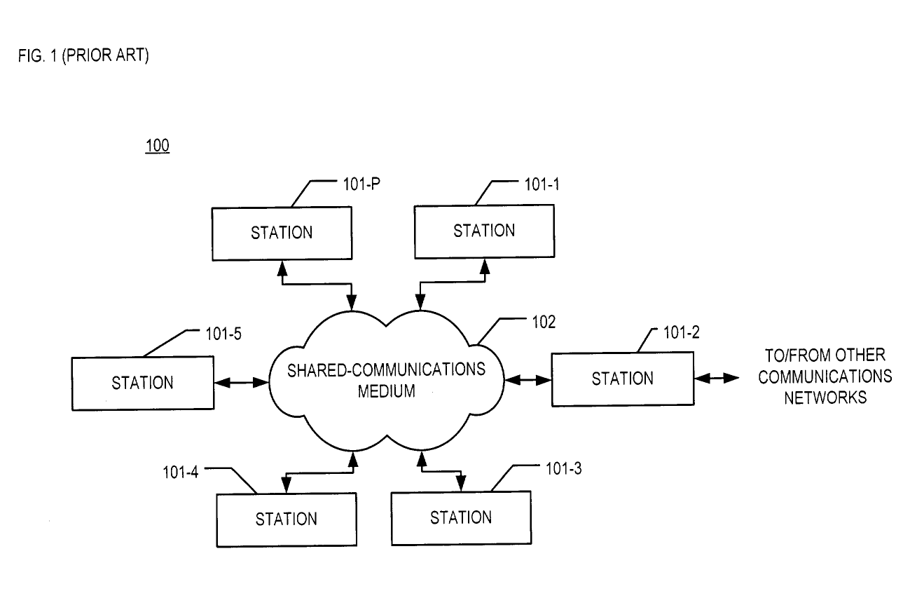

FIG. 2 depicts two stations connected through dedicated transmission channels in the prior art.

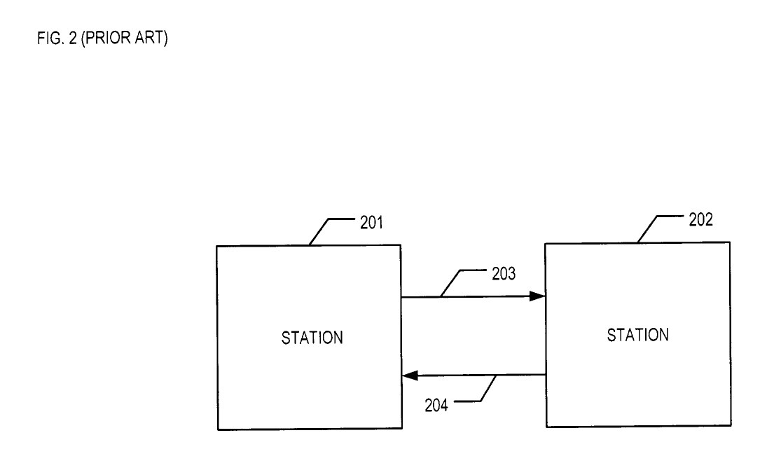

FIG. 3 depicts a schematic diagram of telecommunications system 300 that supports coordinated flows, in accordance with the illustrative embodiment of the present invention.

FIG. 4 depicts a block diagram of the salient components of station 301-h, for h=1 through P, in accordance with the illustrative embodiment of the present invention.

FIG. 5 depicts a series of coordinated flow portions of the first embodiment of the present invention.

FIG. 6 depicts competing access sequences, in accordance with the illustrative embodiment of the present invention.

FIG. 7 depicts a message flow diagram of the first admission control technique, in accordance with the illustrative embodiment of the present invention.

FIG. 8 depicts a message flow diagram of the second admission control technique, in accordance with the illustrative embodiment of the present invention.

FIG. 9 depicts a message flow diagram of the third admission control technique, in accordance with the illustrative embodiment of the present invention.

FIG. 10 depicts a message flow diagram of the second embodiment of the present invention.

FIG. 11 depicts a schematic diagram of the respective coverage areas of depicted stations, in accordance with the illustrative embodiment of the present invention.

FIG. 12 depicts a message flow diagram of the third embodiment of the present invention.

FIG. 13 depicts a message flow diagram of the fourth embodiment of the present invention.

FIG. 14 depicts an access sequence of the fifth embodiment of the present invention.

FIG. 15 depicts a flowchart of the tasks performed by a station seeking to exchange a coordinated flow portion, in accordance with the illustrative embodiment of the present invention.

### DETAILED DESCRIPTION

The following terms in the art are used in this specification, along with corresponding information taken from the IEEE 802.11(e) draft specification, which is incorporated by reference:

Distributed Coordination Function (DCF)-The rules for contention-based access to the wireless medium where the same coordination function logic is active in every station.

Point Coordination Function (PCF)-The rules that provide for centrally-coordinated access to the wireless medium where the coordination function logic is active in only one station (i.e., the point coordinator, typically residing at the access point).

Enhanced Distributed Coordination Function (EDCF)-Analogous to DCF with the added concept of different traffic classes corresponding to different priorities.

Hybrid Coordination Function (HCF)-Analogous to PCF, but allows a Hybrid Coordinator to maintain the states for stations and allocate contention-free transmit opportunities intelligently.

Short Interframe Space (SIFS)-A time interval between frames that is shorter than Point Coordination Function Interframe Space.

Point Coordination Function Interframe Space (PIFS)-A time interval between frames that is longer than SIFS and shorter than Distributed Coordination Function Interframe Space. Also referred to as Point Interframe Space.

Distributed Coordination Function Interframe Space (DIFS)-A time interval between frames that is longer than PIFS. Also referred to as Distributed Interframe Space.

Arbitration Interframe Space (AIFS)-A time interval between frames used in support of the different traffic classes in the EDCF (i.e., one AIFS per traffic class). It can be equal to DIFS or it can be longer than DIFS.

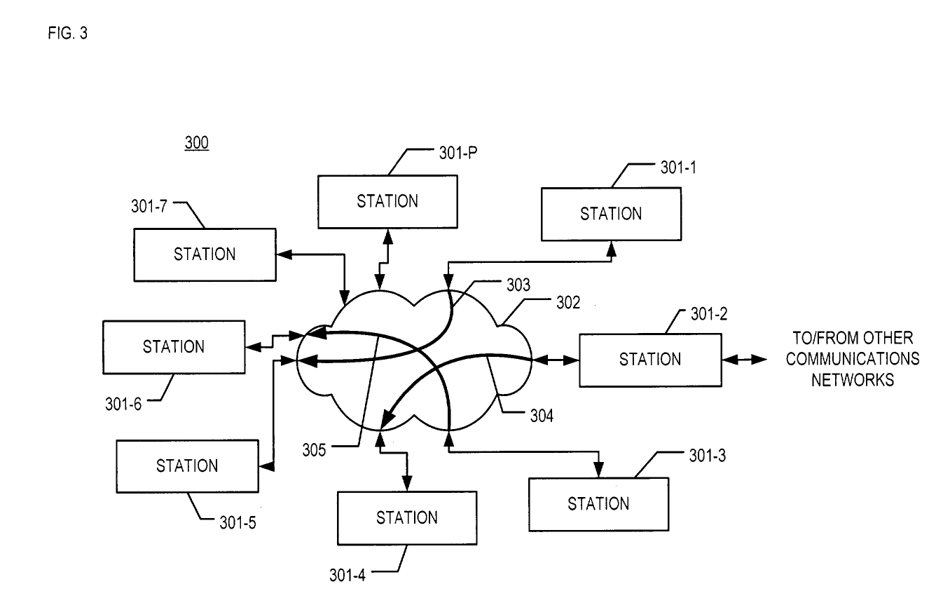

FIG. 3 depicts a schematic diagram of the illustrative embodiment of the present invention, telecommunications system 300, which transmits signals between stations 301-1 through 301-P, wherein P is a positive integer, over shared-communications medium 302. Each of stations 301-1 through 301-P can be a stationary, portable, or mobile type with different types in the mix.

In accordance with the illustrative embodiment, telecommunications system 300 is a packet-switched network, in contrast to a circuit-switched network, as is well known to those skilled in the art. In other words, a macro data structure (e.g., a text file, a part of a voice conversation, etc.) of indefinite size is not necessarily transmitted across shared-communications medium 302 intact, but rather might be transmitted in small pieces.

Each of these small pieces is encapsulated into a data structure called a “data frame,” and each data frame traverses shared-communications medium 302 independently of the other data frames. (Other types of frames also exist, such as control frames.) The intended receiver of the macro data structure collects all of the data frames as they are received, recovers the small pieces of data from each, and reassembles them into the macro data structure.

Shared-communications medium 302 can be wireless or wireline. A salient characteristic of shared-communications medium 302 is that every frame transmitted on shared-communications medium 302 by any station is received or “seen” by every station on shared-communications medium 302, regardless of whether the frame was intended for it or not. In other words, shared-communications medium 302 is effectively a broadcast medium.

If shared-communications medium 302 is wireless, in whole or in part, embodiments of the present invention can use a variety of radio or optical frequencies and transmission methods. Possible radio frequency spectrum, if used, includes the Industrial, Scientific, and Medical (ISM) frequency bands in the ranges of 2.4 GHz and 5.0 GHz. Shared-communications medium 302 can be part of a wireless local area network. In the illustrative embodiments, shared-communications medium 302 constitutes an 802.11 wireless local network. After reading this specification, however, it will be clear to those skilled in the art that embodiments of the present invention can be applied to a non-802.11 network, a non-standardized network (e.g., a proprietary network, etc.), or both.

It will be clear to those skilled in the art how to make and use shared-communications medium 302. It will also be clear to those skilled in the art that shared-communications medium 302 depicted in FIG. 3 is illustrative only and that types of communications networks other than telecommunications system 300 are within the scope of the present invention.

Stations 301-1 through 301-P receive or generate the macro data structure and prepare it for transmission over shared-communications medium 302. The macro data structure can represent, for example, telemetry, text, audio, video, etc. Alternatively, one or more of stations 301-1 through 301-P (e.g., station 301-2, etc.) can function as gateways between shared-communications medium 302 and other communications networks. In functioning as a gateway, a station exchanges the macro data structure with another communications network.

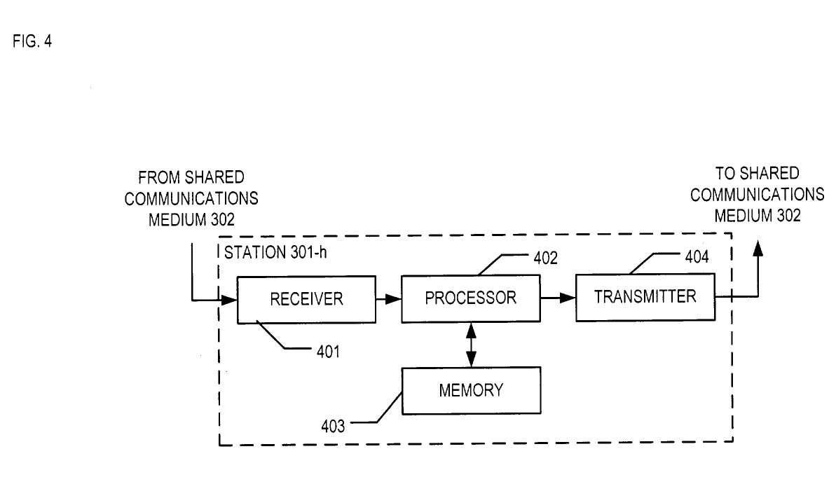

FIG. 4 depicts a block diagram of the salient components of station 301-h, for h=1 through P, in accordance with the illustrative embodiment of the present invention. Station 301-h comprises receiver 401, processor 402, memory 403, and transmitter 404, interconnected as shown.

Receiver 401 comprises the wireless or wireline or hybrid wireless and wireline interface circuitry that enables station 301-h to sense the medium for determining if a signal is present and to receive messages from shared-communications medium 302. When receiver 401 receives a message from shared-communications medium 302, it passes the message to processor 402 for processing. It will be clear to those skilled in the art how to make and use receiver 401.

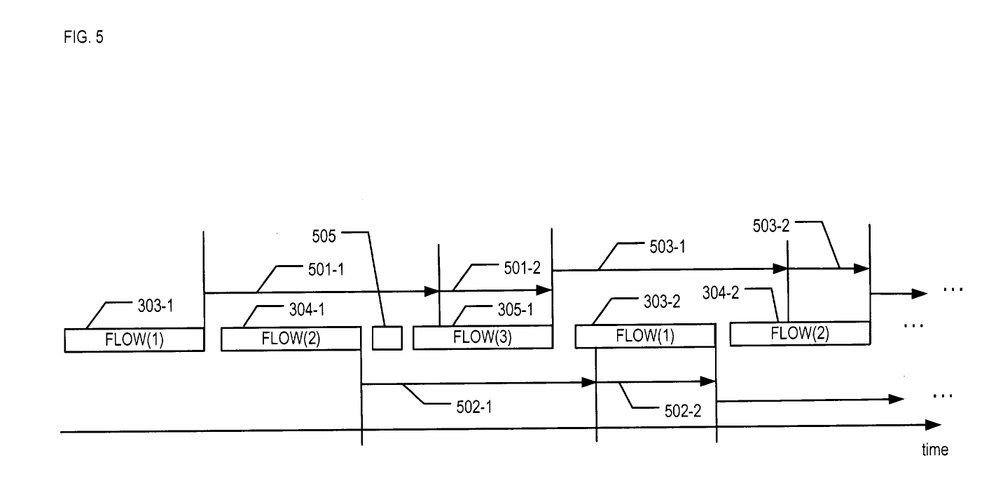

Processor 402 is a general-purpose or special-purpose processor that is capable of performing the functionality described below and with respect to FIGS. 5 through 15. In particular, processor 402 is capable of storing data into memory 403, retrieving data from memory 403, and of executing programs stored in memory 403. It will be clear to those skilled in the art, after reading this specification, how to make and use processor 402.

Memory 403 accommodates input queues and output queues for incoming and outgoing messages (e.g., 802.11 frames, etc.), respectively. It will be clear to those skilled in the art how to make and use memory 403.

Transmitter 404 comprises the wireless or wireline or hybrid wireless and wireline interface circuitry that enables station 301-h to transmit messages onto shared-communications medium 302. It will be clear to those skilled in the art how to make and use transmitter 404.

Stations 301-1 through 301-P need not possess identical capability. Situations involving stations with heterogeneous capabilities can occur, for example, where modern stations are added to a telecommunication system that comprises only legacy stations. Additionally, the situation can result where some, but not all, of the stations in a telecommunications system are upgraded with additional capabilities. Whatever the reason, it will be clear to those skilled in the art why telecommunications systems exist that comprise stations with heterogeneous capabilities.

In accordance with the illustrative embodiment of the present invention, some of stations 301-1 through 301-P are not capable of guaranteeing a particular scheduling order with regards to accessing shared-communications medium 302. For the purposes of this specification, these stations are referred to as “legacy stations.” The example of a legacy station in the illustrative embodiment is an 802.11-capable station without enhancements that promote fairness in scheduling order. In contrast, others of stations 301-1 through 301-P are capable of guaranteeing a scheduling order with regards to accessing shared-communications medium 302. For the purposes of this specification, these stations are referred to as “upgraded stations.” The example of an upgraded station in the illustrative embodiment is a station with enhancements that promote fairness in scheduling order, either 802.11-based or proprietary. In accordance with the illustrative embodiment of the present invention, legacy stations and upgraded stations are capable of communicating with each other because the upgraded stations transmit messages that are intended for legacy stations in the format that is understood by and compatible with the legacy stations. Furthermore, the messages described to be used for the purpose of enabling a fair scheduling order are compatible with legacy stations. It will be clear to those skilled in the art how to make and use messages specifically for upgraded stations that can be made backwards compatible with legacy stations.

A plurality of stations 301-1 through 301-P are able to access communications medium 302. Furthermore, the upgraded stations-depicted in the illustrative embodiment as station 301-1, station 301-2, station 301-3, station 301-4, station 301-5, and 301-6 are able to communicate with each other while maintaining a fair scheduling order with respect to accessing shared-communications medium 302. In any given time period, the upgraded stations can communicate up to N such coordinated flows to each other, where N is a positive integer. A flow is a stream of communication comprising frames between any two stations. A coordinated flow is a stream of communication comprising frames between two stations, in which the transmit times of the flows are scheduled fairly (e.g., in “round-robin” fashion, etc.). A flow between two stations can comprise data frames in one direction and acknowledgement frames in the other direction.

In FIG. 3, coordinated flow 303 is being communicated by station 301-1 with station 301-5. Coordinated flow 304 is being communicated by station 301-2 with station 301-4. Coordinated flow 305 is being communicated by station 301-3 with station 301-6. Other flows (coordinated or not) between alternative station pairs are possible. An admission control protocol enforces the maximum of N coordinated flows of fair scheduling order, that is, flows scheduled fairly with stations taking turns at using shared-communications medium 302. Furthermore, the N coordinated flows are associated with a high, shared-communications medium access priority. Admission control and characteristics related to high priority are described later.

It is also possible that two or more coordinated flows all originate within (i.e., are transmitted from) the same physical station or all terminate into (i.e., are received by) the same physical station. An example of this is two Internet browser sessions opened within the same station, each session contributing a different stream of data (e.g., video stream, audio stream, etc.). It will be clear to those skilled in the art how to handle more than one flow (coordinated or not) within the same physical station.

In the examples that follow, station 301-2 serves in the examples as the hybrid coordinator and also as the access point of shared-communications medium 302, unless otherwise specified. It will be clear to those skilled in the art how to make and use a hybrid coordinator and an access point. It will also be clear to those skilled in the art that separate stations can be used to support the hybrid coordinator and the access point functions. It will also be clear to those skilled in the art that the station serving as hybrid coordinator or access point or both can also be the station either transmitting or receiving coordinated flows on shared-communications medium 302.

FIG. 5 depicts a sequence of coordinated flows of the first embodiment of the present invention. Each coordinated flow is divided into portions, where each portion comprises frames (e.g., data frames, acknowledgement frames, etc.) that can be transmitted without interruption. Flow 303 comprises sequential portions 303-1, 303-2, and so on. Flow 304 comprises sequential portions 304-1, 304-2, and so on. Similarly, flow 305 comprises sequential portion 305-1, and so on.

In accordance with the illustrative embodiment, when station 301-1 finishes transmitting portion 303-1, station 301-1 self-imposes a restriction as to when it can attempt to transmit the next portion (i.e., portion 303-2). Specifically, station 301-1 must wait a time interval that it calculates before attempting to transmit portion 303-2. This restriction interval is greater than or equal to T*(N−1) milliseconds. N has already been defined. T is equal to the maximum length that a portion can be in milliseconds. Portions can be different sizes or of equal size across different flows. Portions can be different sizes or of equal size within a given flow.

To ensure that flows are scheduled fairly (i.e., are coordinated), the self-imposed time restriction must end no earlier than during the flow that precedes the scheduled time for the station that imposes the restriction on itself. As depicted in FIG. 5, station 301-1 self-imposes interval 503-1 to ensure that station 301-1 does not attempt to transmit another portion until portion 305-1 is in the process of being transmitted. Furthermore, because portion 305-1 is being transmitted when station 301-1's restriction interval ends, station 301-1 will then wait until it senses in well-known fashion that shared-communications medium 302 is idle (i.e., it uses physical carrier sensing). In addition, station 301-1 will have been tracking through its network allocation vector (NAV), in well-known fashion, interval 501-2 remaining in the transmission of portion 305-1 (i.e., it uses virtual carrier sensing). Once station 301-1 senses (physically, virtually, or both) that portion 305-1 is no longer being transmitted, station 301-1 can attempt to access shared-communications medium 302 to transmit portion 303-2. The access sequence is described in detail later.

Also depicted in FIG. 5, station 301-2 transmits portion 304-1. Station 301-2 then self-imposes interval 502-1 to ensure that station 301-2 does not attempt to transmit another portion until portion 303-2 is in the process of being transmitted. Furthermore, because portion 303-2 is being transmitted, station 301-2 will wait until it senses in well-known fashion that shared-communications medium 302 is idle (i.e., it uses physical carrier sensing). In addition, station 301-2 will have been tracking through its network allocation vector (NAV), in well-known fashion, interval 502-2 remaining in the transmission of portion 303-2 (i.e., it uses virtual carrier sensing). Once station 301-2 senses (physically, virtually, or both) that portion 303-2 is no longer being transmitted, station 301-2 can attempt to access shared-communications medium 302 to transmit portion 304-2.

Similarly, station 301-3 transmits portion 305-1. Station 301-3 then self-imposes interval 503-1 to ensure that station 301-3 does not attempt to transmit another portion until portion 304-2 is in the process of being transmitted. Furthermore, because portion 304-2 is being transmitted, station 301-3 will wait until it senses in well-known fashion that shared-communications medium 302 is idle (i.e., it uses physical carrier sensing). In addition, station 301-3 will have been tracking through its network allocation vector (NAV), in well-known fashion, interval 503-2 remaining in the transmission of portion 304-2 (i.e., it uses virtual carrier sensing). Once station 301-3 senses (physically, virtually, or both) that portion 304-2 is no longer being transmitted, station 301-3 can attempt to access shared-communications medium 302 to transmit the next portion.

It is possible for a station (either legacy or upgraded) to transmit frames not part of coordinated flows between transmissions of coordinated flow portions. Frame 505 is an example of such an incidental frame. A technique in accordance with the illustrative embodiment for transmitting incidental frames is described later.

To allow for the contention period between flows, in some embodiments, each station waits at least (T+K)*(N−1) milliseconds before contending for access to shared-communications medium 302. T and N are defined above. K is a padding factor in milliseconds to allow for gaps between successive portions being transmitted. K can be equal to the length in milliseconds of the arbitration interframe space governing the stations on shared-communications medium 302. Alternatively, K can be greater than the length of the arbitration interframe space.

In accordance with the illustrative embodiment of the present invention, a station can place itself in power save mode during the period in which it is waiting before it can transmit another portion of a coordinated flow. This is because the restriction interval is deterministic, allowing the sending station, the receiving station, or both to turn off their transmitters, receivers, or both for a known period. The transmitter and receiver at each station turn on again before the end of the restriction interval (before the station can contend again for access). It will be clear to those skilled in the art how to implement a power save mode at one or more stations. It will also be clear to those skilled in the art when during the restriction interval to turn off and turn back on components within a station as part of a power save mode.

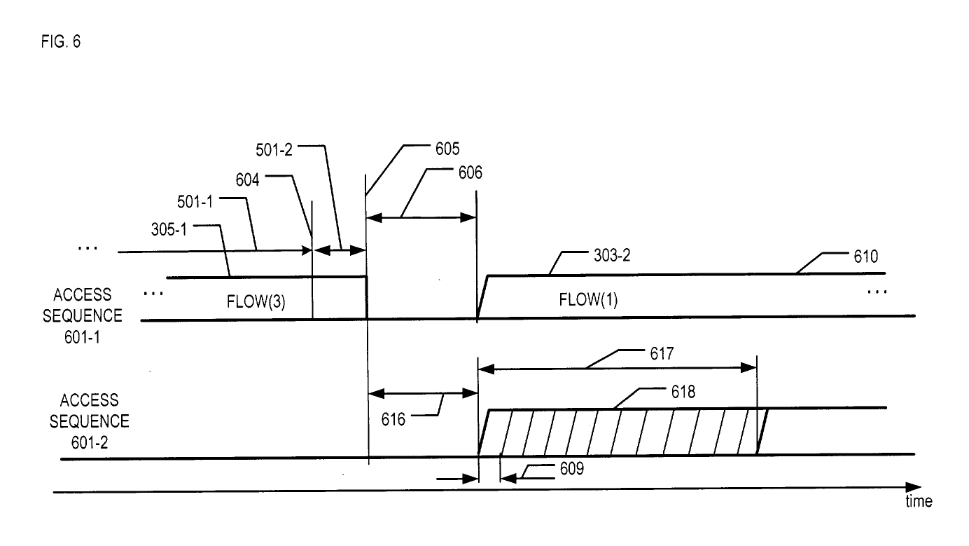

FIG. 6 depicts access sequence 601-1 comprising the events integral to accessing shared-communications medium 302 for the purpose of transmitting a coordinated flow. Stations that are capable of transmitting coordinated flows gain access to shared-communications medium 302 by following protocols that are in accordance with the illustrative embodiment of the present invention.

Using the example provided earlier, station 301-1 has transmitted portion 303-1 at an earlier time and is already in the restriction time interval indicated by interval 501-1. Meanwhile, portion 304-1 has also been transmitted. Portion 305-1, of length T, is being transmitted when interval 501-1 ends (at time 604). Even though interval 501-1 ends, station 301-1 still carrier senses (physically, virtually, or both) in well-known fashion through interval 501-2. Station 301-1 detects in well-known fashion at time 605 that shared-communications medium 302 is idle. In accordance with the illustrative embodiment, station 301-1 seeking access waits for backoff period 606, equal to the length of the arbitration interframe space governing station 301-1, starting from time 605. At the end of backoff period 606 and if access is permitted, station 301-1 transmits portion 303-2. (The techniques of acquiring access permission are described later.) Alternatively, prior to transmitting portion 303-2, Station 301-1 can transmit a Request_ to_ Send (RTS) frame and then expect to receive a Clear_to_Send (CTS) frame, the significance of which is described later.

Concurrent with the events described above, another station, legacy station 301-7 as an example, could also be attempting to access shared-communications medium 302 in well-known fashion, as depicted in access sequence 601-2. Station 301-7 seeking access waits for interframe space 616, equal to the length of the arbitration interframe space governing station 301-7, starting from time 605. Station 301-7 then waits the length of backoff period 618, as calculated by station 301-7. Station 301-7 calculates in well-known fashion the length of backoff period 618 by using the length of contention window 617 in a randomizing function and by using the length of timeslot 609. If calculated in this way, backoff period 618 varies in length by multiples of timeslot 609 from one access attempt to another, as represented by the multiple appearances of timeslot 609 in FIG. 6.

The interval that is the length of backoff period 606 is shorter than the interval that is the sum of the lengths of interframe space 616 and backoff period 618 in most practical cases. Therefore, station 301-1 beats station 301-7 in gaining access to shared-communications medium 302. If station 301-7 has to transmit one or more frames, it has to wait until conditions favor it. Examples of such conditions include a coordinated flow scenario with a particular transmitted portion that is of length significantly shorter than T, in which case, stations still in self-imposed waiting will not be ready to contend with station 301-7 for access, and station 301-7 wins access. In another example, station 301-7 can be polled, as described later.

Access to shared-communications medium 302 for the purpose of transmitting a coordinated flow is governed by admission control, which enforces the characteristic of no more than N coordinated flows being present during a given time period. Admission control can also be used to indicate to a particular station if that station is permitted to transmit a portion of a coordinated flow. Permission can be granted or denied based on the station requesting access, on the status of flows already being transmitted, or on a combination of factors. For instance, the transmission of coordinated flows might be pre-empted by another service or function using shared-communications medium 302. In other words, admission control is used to determine and indicate if shared-communications medium 302 is accessible to a particular station or stations at a particular moment in time for the purpose of transmitting a coordinated flow portion. It will be clear to those skilled in the art how to determine criteria that define accessibility.

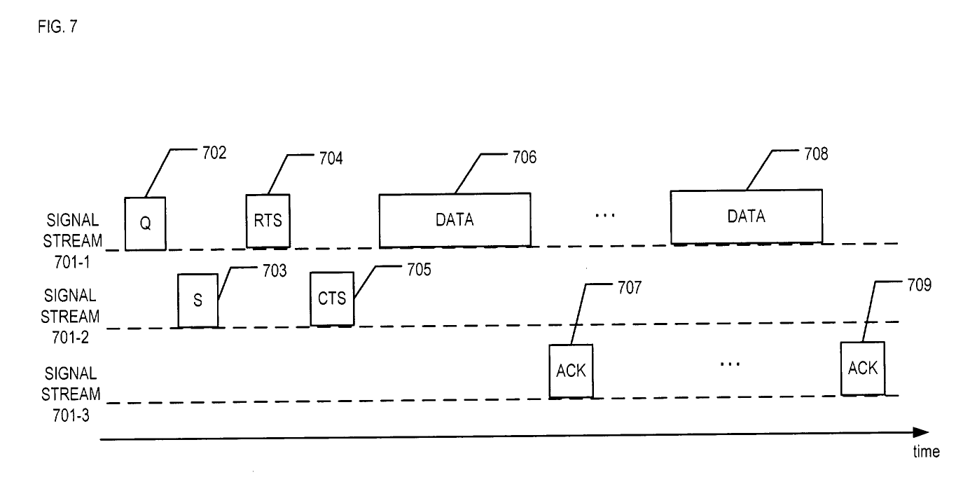

There are three admission control techniques disclosed in accordance with the illustrative embodiment of the present invention. FIG. 7 depicts a message flow diagram of the first of three variations of admission control, in accordance with the illustrative embodiment of the present invention. Signal stream 701-1 represents the sequence of messages transmitted on shared-communications medium 302 by station 301-1 seeking access for the purpose of transmitting a coordinated flow to station 301-6. Signal stream 701-2 represents the sequence of messages transmitted by station 301-2, the access point, on shared-communications medium 302. Signal stream 701-3 represents the sequence of messages transmitted by station 301-6 on shared-communications medium 302.

In the first variation, station 301-1 seeking access sends query message 702 (i.e., “Q” for “query” ) to station 301-2. Query message 702 serves to determine whether or not additional flows can be coordinated. Station 301-2 responds to query message 702 with status message 703 (i.e., “S” for “status”). The purpose of status message 703 is to indicate whether or not station 301-1 is allowed to transmit a coordinated flow. In the example, station 301-2 informs station 301-1 that station 301-1 is allowed to transmit.

After admission control, station 301-1 executes an RTS frame 704/CTS frame 705 exchange with station 301-2, in accordance with the illustrative embodiment of the present invention. The RTS/CTS exchange is described in detail later. Station 301-1 then communicates a portion of a coordinated flow to station 301-6, comprising data frames 706 and 708 (of possibly many frames) and corresponding acknowledgement frames (“ACK” frame) 707 and 709.

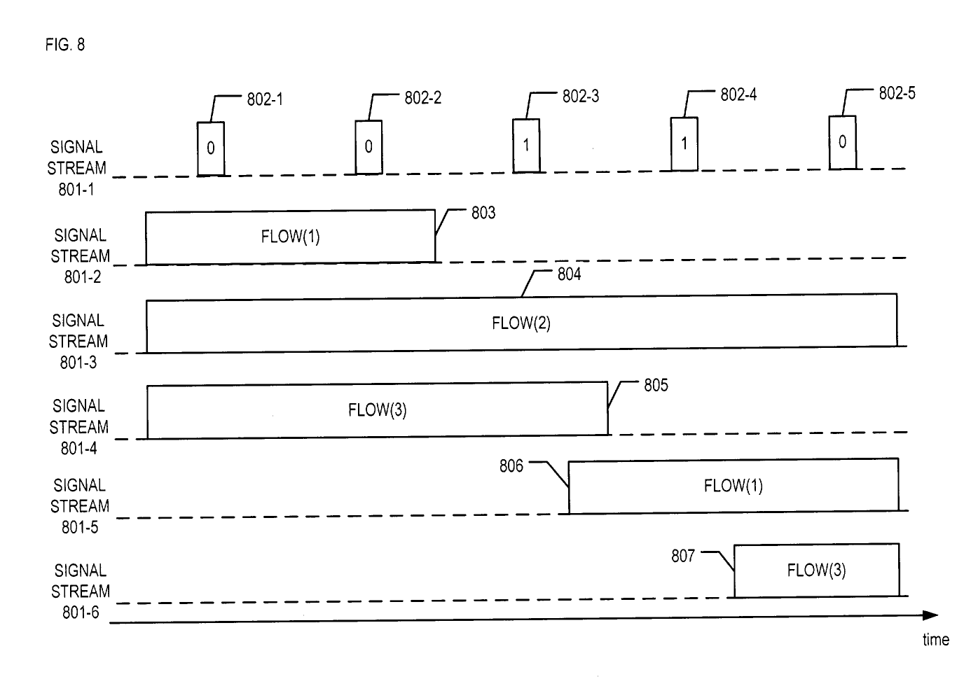

FIG. 8 depicts a message flow diagram of the second variation of admission control, in accordance with the illustrative embodiment of the present invention. Signal stream 801-1 represents the sequence of status messages transmitted by station 301-2, the access point, on shared-communications medium 302. In the example, the status messages are represented by periodically-transmitted beacon frames. Signal streams 801-2, 801-3, 801-4, 801-5, and 801-6 respectively represent the sequence of messages transmitted on shared-communications medium 302 by stations 301-1, 301-3, 301-4, 301-5, and 301-6 seeking access on shared-communications medium 302 for the purpose of transmitting coordinated flows. In the example, a maximum of three coordinated flows are allowed concurrently. Each coordinated flow comprises one or more portions of data frames.

Stations 301-1, 301-3, and 301-4 are initially in the process of transmitting flows 803, 804, and 805 respectively. Station 301-2, the access point, reflects this by indicating in beacon frames 802-1 and 802-2 that there are zero (0) opportunities available for another station to transmit a coordinated flow.

Station 301-1 then stops transmitting flow 803, while stations 301-3 and 301-4 continue to transmit. This is reflected in beacon frame 802-3, which indicates that there is one (1) opportunity available for another station to transmit a coordinated flow.

Station 301-5, in seeking to transmit a coordinated flow, first reads the information from beacon frame 802-3 and determines that it is permitted to contend for access to transmit. Station 301-5 starts transmitting flow 806. Shortly thereafter, station 301-4 stops transmitting flow 805. The next beacon frame 802-4 continues to show that there is one (1) opportunity available for another station to transmit a coordinated flow, even though a different mix of stations are transmitting flows at the end of the pertinent beacon interval compared with the mix of stations that were transmitting flows at the beginning of the beacon interval.

Station 301-6, in seeking to transmit a coordinated flow, first reads the information from beacon frame 802-4 and determines that it is permitted to contend for access to transmit. Station 301-6 starts transmitting flow 807. Stations 301-3 and 301-5 continue to transmit flows. Consequently, beacon frame 802-5 reflects this by indicating that there are zero (0) opportunities available for another station to transmit a coordinated flow.

It will be clear to those skilled in the art how to periodically distribute system status information, either by using beacon frames or other messages, to indicate whether or not additional coordinated flows can be transmitted. It will also be clear to those skilled in the art how to represent the status information (e.g., number of additional coordinated flows permitted, number of coordinated flows already present, etc.).

Station 301-2 can also distribute other parameters related to coordinated flows. For instance, the access point can transmit beacon frames that comprise information related to parameters T, N, and K. This allows the access point to tune how much bandwidth is allocated to coordinated flow traffic on shared-communications medium 302. It will be clear to those skilled in the art how to distribute parameters related to coordinated flows via the access point to other stations.

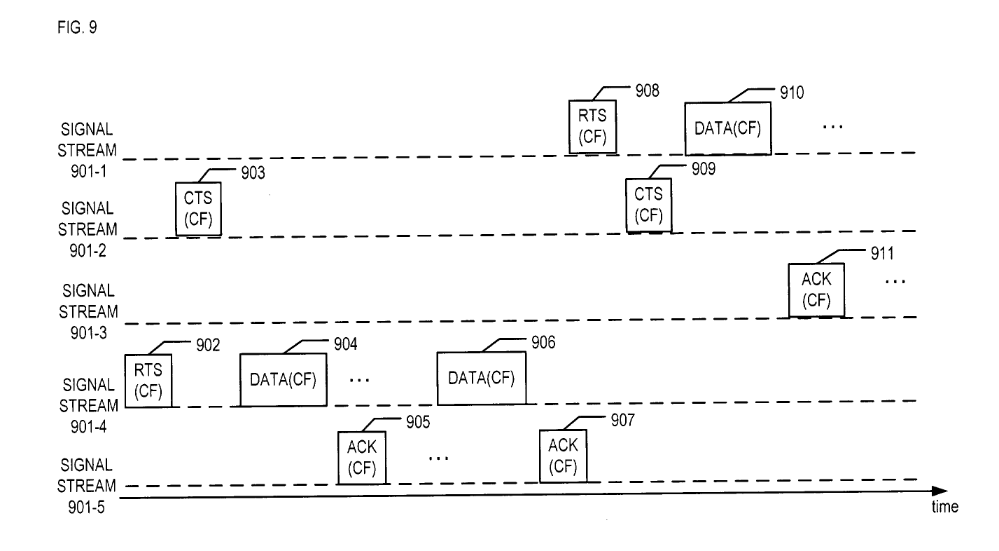

FIG. 9 depicts a message flow diagram of the third variation of admission control, in accordance with the illustrative embodiment of the present invention. Signal stream 901-1 represents the sequence of messages transmitted on shared-communications medium 302 by station 301-1 seeking access on shared-communications medium 302 for the purpose of transmitting a coordinated flow to station 301-3. Signal stream 901-2 represents the sequence of messages transmitted by station 301-2, the access point, on shared-communications medium 302. Signal stream 901-3 represents the sequence of messages transmitted by station 301-3 on shared-communications medium 302. Signal stream 901-4 represents the sequence of messages transmitted by station 301-4 on shared-communications medium 302. Signal stream 901-5 represents the sequence of messages transmitted by station 301-5 on shared-communications medium 302. In addition, three other station pairs (not shown) are already exchanging coordinated flows. In the example, N is equal to four.

In the third variation, station 301-1 seeking access monitors transmissions on shared-communications medium 302 during the interval in which stations 301-4 and 301-5 are exchanging a coordinated flow, as well as the three other station pairs not shown. Each transmitting station (e.g., stations 301-4 and 301-5, etc.) tags each data frame transmitted as part of a coordinated flow, depicted by frames 904 and 906 (i.e., “CF” for “coordinated flow”). The tag is a unique label distinguishable from other information fields in the frame. It will be clear to those skilled in the art how to tag a message to reflect a specific condition. Transmitted control frames that are associated with coordinated flows (e.g., RTS frame 902, CTS frame 903, ACK frames 905 and 907, etc.) can also be tagged. Tagging of control frames increases the spatial coverage of the presence of traffic because control frames are transmitted from different spatial locations than that of the station transmitting the data frames and possibly at a lower physical layer rate.

Since station 301-1 sees frames tagged with indications corresponding to at least four coordinated flows during the search interval and since four is the maximum allowed in the example (i.e., N=4), station 301-1 does not attempt to transmit a coordinated flow. It will be clear to those skilled in the art how to determine a suitable search interval in which to detect the presence or absence of certain types of messages, such as tagged frames, etc.

Station 301-4 eventually finishes its sequence that is used in communicating with station 301-5. Subsequently, station 301-1 sees that a transmission opportunity is available by detecting less than N coordinated flows present during another search interval. After admission control, station 301-1 exchanges an RTS frame 908/CTS frame 909 sequence with station 301-2, in accordance with the illustrative embodiment of the present invention. This is described in detail later. Station 301-1 then communicates a portion of a coordinated flow with station 301-3, comprising data frame 910 (of possibly many frames) with corresponding ACK frame 911. Note that frames 908, 909, 910, and 911 are tagged (i.e., “CF”), indicating the traffic that is part of a coordinated flow.

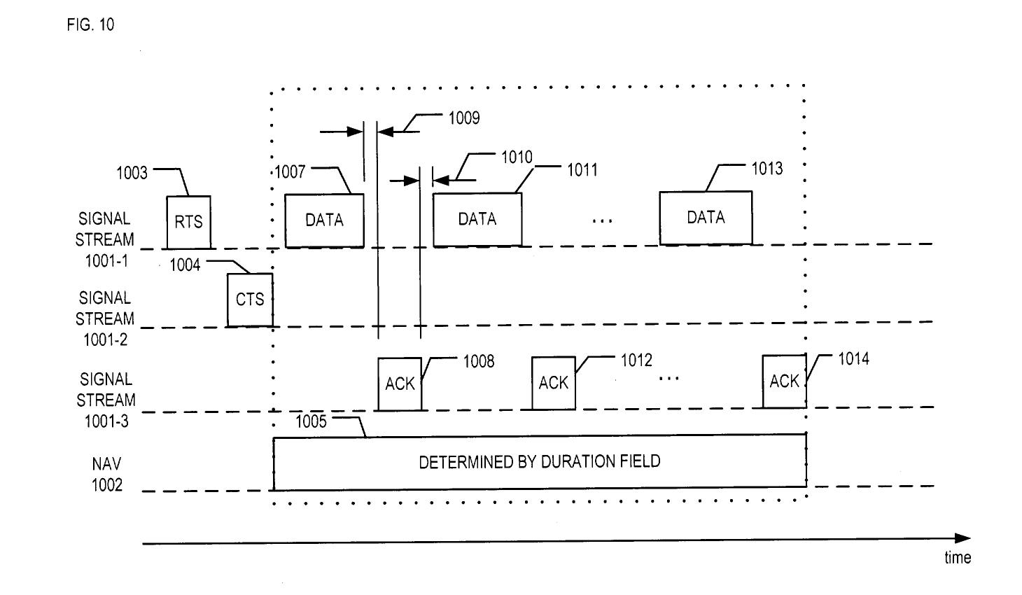

FIG. 10 depicts a message flow diagram, in accordance with the second illustrative embodiment of the present invention. Specifically, FIG. 10 depicts an example of a sequence to be transmitted comprising a coordinated flow portion, in accordance with the illustrative embodiment of the present invention. Signal stream 1001-1 represents the sequence of messages transmitted on shared-communications medium 302 by station 301-1 for the purpose of communicating with station 301-3. Signal stream 1001-2 represents the sequence of messages transmitted by station 301-2, the access point, on shared-communications medium 302. Signal stream 1001-3 represents the sequence of messages transmitted by station 301-3. NAV timeline 1002 tracks the status of the network allocation vector for stations within receiving range of station 301-2. The network allocation vector supports the virtual carrier sensing function of those stations. The network allocation vector is set by the duration field in CTS frame 1004 and can also be set by other frames. It will be clear to those skilled in the art how to use the network allocation vector, virtual carrier sensing function, and duration field.

The sequence to be exchanged comprises Request_to_Send (RTS) frame 1003; Clear_to_Send (CTS) frame 1004; data frames 1007, 1011, and 1013; and acknowledgement (ACK) frames 1008, 1012, and 1014. Station 301-1 starts off by transmitting RTS frame 1003 to station 301-2 in well-known fashion. Station 301-1 sets the duration field in RTS frame 1003 to the calculated transmission time remaining in the sequence (i.e., through the end of the portion to be transmitted), in accordance with the illustrative embodiment of the present invention. This has the effect of providing stations within receiving range of station 301-1 with virtual carrier sensing information. RTS frame 1003 is transmitted to station 301-2 whether the subsequent coordinated flow portion (i.e., comprising data frames and ACK frames depicted) is also communicated with station 301-2 or to another station (e.g., station 301-3). It will be clear to those skilled in the art how to convey duration field information by using a frame (i.e., RTS, CTS, or other frame type).

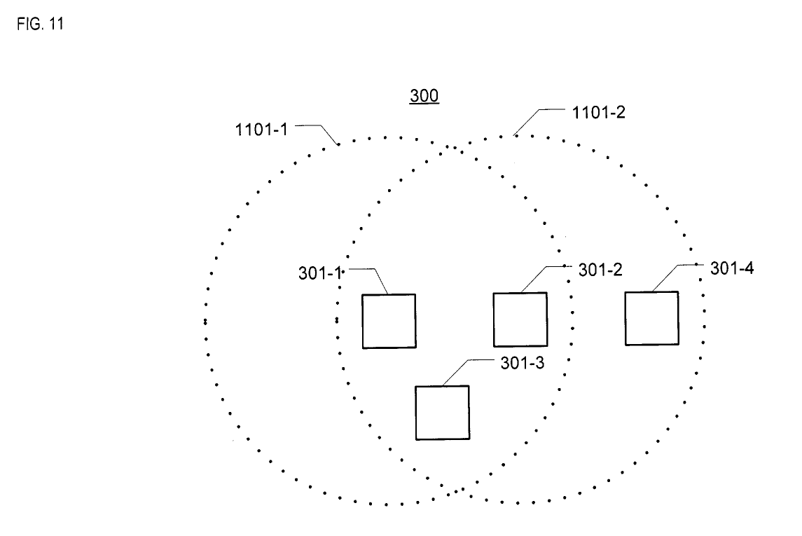

Upon receiving RTS frame 1003, station 301-2 responds by transmitting CTS frame 1004 to station 301-1 in well-known fashion. Station 301-2 sets the duration field in CTS frame 1004 based on what was received in RTS frame 1003. This has the effect of quieting all stations (via virtual carrier sensing) within receiving range of station 301-2 during the remaining part of the sequence, as depicted in FIG. 11. Station 301-1 has a range represented by coverage ring 1101-1, which is not sufficient to reach station 301-4 (i.e., stations 301-1 and 301-4 are “hidden” from each other). In contrast, station 301-2 has a range represented by coverage ring 1101-2, which is sufficient to reach all stations in the area. Consistent with performing its hybrid coordinator or access point function within telecommunications system 300, station 301-2 is located within the BSS area where all stations can hear station 301-2.

The duration field value representing time interval 1005 is derived in well-known fashion from the duration field value provided by RTS frame 1003, accounting for the short interframe space between RTS frame 1003 and CTS frame 1004, as well as the duration of CTS frame 1004 itself. The duration field used in RTS frame 1003 can be calculated, for example, at station 301-1 by adding up the anticipated transmission times of the relevant signals to be subsequently transmitted (e.g., CTS frame, data frames, ACK frames, etc.) and the lengths of the associated interframe spaces between frames. The value can be determined empirically, it can be estimated, or it can be determined in another way. It can comprise a margin of variation in transmission, or it can comprise no extra margin. It can be adjusted to ensure that quieted stations will not remain silent past the very end of the coordinated flow portion. It will be clear to those skilled in the art how to calculate and set the value of the duration field in RTS frame 1003.

Upon receiving CTS frame 1004, station 301-1 initiates the coordinated flow portion by transmitting data frame 1007 in well-known fashion. Data frame 1007 is the first of possibly many data frames constituting the current portion being communicated. Alternatively, data frame 1007 or individual data frames that follow can comprise multiple frames that have been concatenated into a single frame. Concatenation increases the efficiency of shared-communications medium 302 because it reduces the medium access control and physical layer header overhead. Concatenation can occur during the restriction interval immediately preceding the transmission of the current portion. It will be clear to those skilled in the art how to save up frames for transmission and to concatenate two or more saved frames together into a single frame.

Station 301-3, upon receiving data frame 1007, responds by transmitting ACK frame 1008 in well-known fashion. Station 301-1 then follows up by transmitting data frame 1011, and so on. The coordinated flow portion ends when the final ACK frame in the portion (i.e., ACK frame 1014) is received by station 301-1. The interval between each data frame and the corresponding ACK frame, interval 1009, is the length of short interframe space, as is known in the art. The interval between each ACK frame and the next data frame, interval 1010, is also the length of short interframe space, as is known in the art.

It will be clear to those skilled in the art how to format, encode, transmit, receive, and decode RTS frame 1003; CTS frame 1004; data frames 1007, 1011, and 1013; and ACK frames 1008, 1012, and 1014.

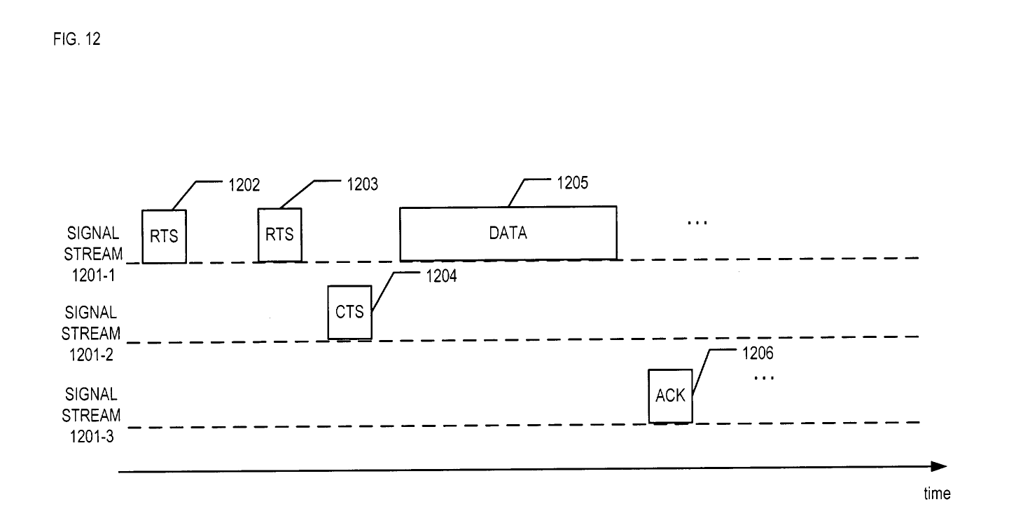

FIG. 12 depicts a message flow diagram, in accordance with the third illustrative embodiment of the present invention. Signal stream 1201-1 represents the sequence of messages transmitted on shared-communications medium 302 by station 301-1 for the purpose of communicating with station 301-3. Signal stream 1201-2 represents the sequence of messages transmitted by station 301-2, the access point, on shared-communications medium 302. Signal stream 1201-3 represents the sequence of messages transmitted by station 301-3.

Station 301-1 starts off by transmitting RTS frame 1202 to station 301-2 in well-known fashion. Station 301-1 can set the duration field in RTS frame 1202 to provide stations within receiving range of station 301-1 with virtual carrier sensing information.

In this example, station 301-1 never receives a CTS frame that corresponds to RTS frame 1202. In accordance with the illustrative embodiment of the present invention, station 301-1 assumes that a “short” collision has occurred. A short collision can indicate a collision with another RTS frame sent by another station also seeking to transmit a coordinated flow portion, so a random backoff is required to separate the coordinated flow portions across the two stations. Consequently, station 301-1 retransmits an RTS frame, RTS frame 1203, but only after waiting for a backoff interval equal to the arbitration interframe space governing station 301-1 plus a random number of slots, in accordance with the illustrative embodiment of the present invention.

Upon receiving RTS frame 1203, station 301-2 responds by transmitting CTS frame 1204 to station 301-1 in well-known fashion. Station 301-2 sets the duration field in CTS frame 1204 to quiet other stations, as already described.

Upon receiving CTS frame 1204, station 301-1 transmits data frame 1205 in well-known fashion. Station 301-3, upon receiving data frame 1205, responds by transmitting ACK frame 1206 in well-known fashion. Stations 301-1 and 301-3 then follow up by exchanging the remaining frames in the coordinated flow portion.

It will be clear to those skilled in the art how to format, encode, transmit, receive, and decode RTS frame 1202 and 1203, CTS frame 1204, data frame 1205, and ACK frame 1206.

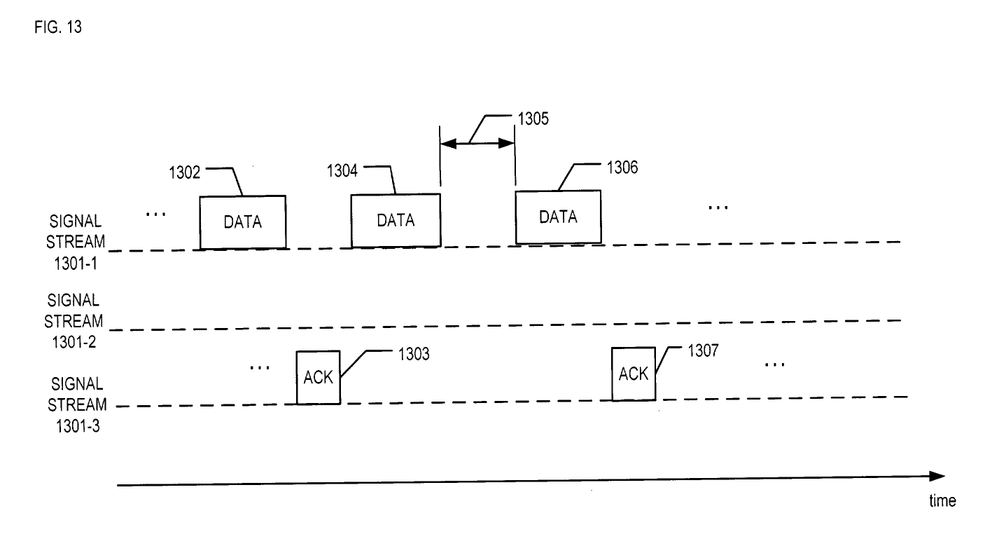

FIG. 13 depicts a message flow diagram in accordance with the fourth illustrative embodiment of the present invention. Signal stream 1301-1 represents the sequence of messages transmitted on shared-communications medium 302 by station 301-1 for the purpose of communicating with station 301-3. Signal stream 1301-2 represents the timeline of station 301-2, the access point/hybrid coordinator, on shared-communications medium 302. Signal stream 1301-3 represents the sequence of messages transmitted by station 301-3. In this example, station 301-1 is in the middle of a coordinated flow portion already in progress, exchanging frames with station 301-3.

Station 301-1 transmits data frame 1302 in well-known fashion. Station 3013, upon receiving data frame 1302, responds by transmitting ACK frame 1303 in well-known fashion. Station 301-1 then follows up by transmitting data frame 1304. Station 301-1 then expects to receive corresponding ACK frame, but does not.

It is important that the coordinated flow transmissions get restarted as quickly as possible to prevent station 301-2 (or other stations) from attempting to transmit on shared-communications medium 302. The restart interval has to be relatively short, since a hybrid coordinator uses point interframe space (PIFS) to determine when it attempts to transmit, as is known in the art. Therefore, in accordance with the illustrative embodiment of the present invention, station 301-1 waits the length of PIFS, corresponding to interval 1305, after having transmitted data frame 1304 and then retransmits the data frame, represented by data frame 1306. Station 301-1 concludes within interval 1305 that the ACK frame is missing and that it must retransmit the data frame. Station 301-3 acknowledges receipt of data frame 1306 by transmitting back ACK frame 1307. Stations 301-1 and 301-3 continue exchanging frames until finished, without interruption from station 301-2.

It will be clear to those skilled in the art how to format, encode, transmit, receive, and decode data frames 1302, 1304, and 1306, and ACK frames 1303 and 1307.

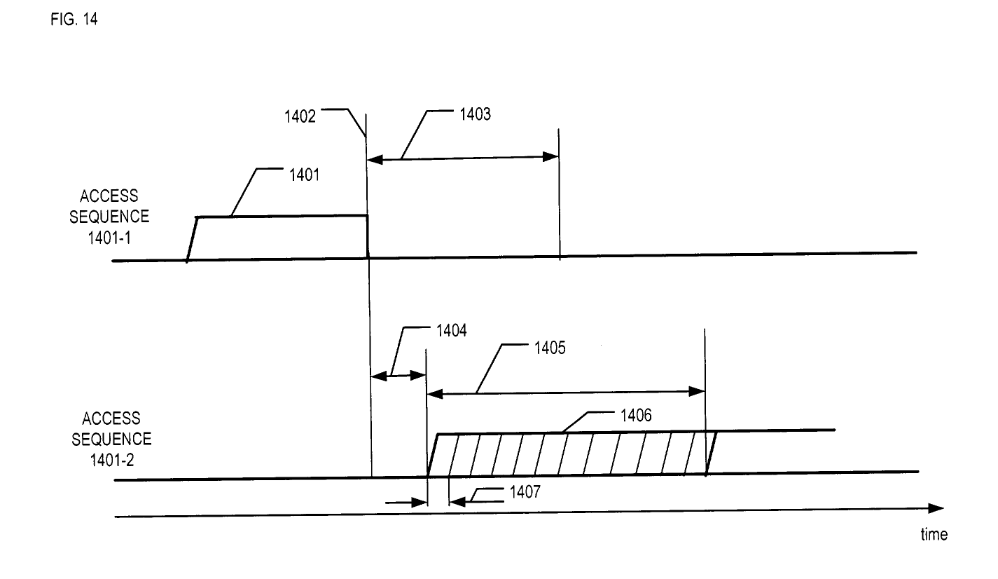

Traffic with a low latency tolerance but not necessarily requiring a high data rate (e.g., voice traffic, etc.) will have to contend with coordinated flow traffic for overall access to shared-communications medium 302. In this case, the priority traffic not part of a coordinated flow that needs to be mixed with coordinated flow traffic is polled from a central location, in accordance with the illustrative embodiment of the present invention. FIG. 14 depicts access sequences in accordance with the fifth illustrative embodiment of the present invention. Access timing sequence 1401-1 represents the procedure of station 301-1 on shared-communications medium 302. Access timing sequence 1401-2 represents the procedure of station 301-2, as hybrid coordinator (i.e., the central location used for polling), accessing shared-communications medium 302 in a timely manner. In short, stations 301-1 and 301-2 are vying for contention of some of the same shared resources at the same time. Both sequences start at the time point in time, at which busy medium 1401 becomes idle. In well-known fashion, both stations 301-1 and 301-2 carrier-sense at time 1402 that shared-communications medium 302 has become idle and start timing the interframe space. Station 301-1 seeking access to transmit a coordinated flow waits for backoff interval 1403 equal to the length of the arbitration interframe space (AIFS). In contrast, station 301-2 waits for interframe space 1403, equal to the length of the point interframe space (PIFS), which is shorter than the length of the AIFS used by station 301-1. Consequently, station 301-2 gets an advantage over station 301-1 in accessing shared-communications medium 302.

Subsequent to waiting backoff interval 1403, station 301-1 can then transmit. Meanwhile, on its own timeline and after waiting interframe space 1404, station 301-2 calculates and then waits the length of its backoff period 1406, as calculated by station 301-2. Station 301-2 calculates in well-known fashion the length of backoff period 1406 using the length of contention window 1405 in a randomizing function and the length of timeslot 1407. Backoff period 1406 can vary in length from one access attempt to another, as represented by the multiple appearances of timeslot 1407. At the end of backoff period 1406, station 301-2 can initiate a polled traffic sequence with one or more other stations for the purposes of exchanging the polled (e.g., voice, etc.) traffic. The polled traffic sequence comprises one or more data frames and corresponding ACK frames. Station 301-2 can be part of the actual data frame exchange, or the data frame exchange can involve stations other than station 301-2. It will be clear to those skilled in the art how a hybrid coordinator and associated stations use polling to exchange information.

As depicted in FIG. 14, the polled traffic is able to compete for access to shared-communications medium 302, since the combined intervals 1404 and 1405 can be adjusted to be shorter than backoff interval 1403, at least statistically over many access sequences, in accordance with the illustrative embodiment of the present invention.

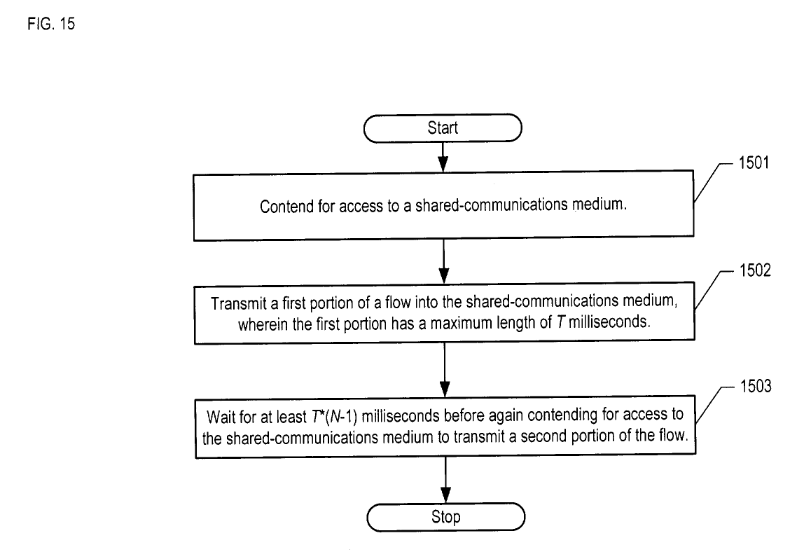

FIG. 15 depicts a flowchart of the tasks performed by station 301-1 in accessing shared-communications medium 302 for the purpose of exchanging a coordinated flow, in accordance with the illustrative embodiment of the present invention. It will be clear to those skilled in the art which of the tasks depicted in FIG. 15 can be performed simultaneously or in a different order than that depicted.

At task 1501, station 301-1 contends for access to shared-communications medium 302. It will be clear to those skilled in the art how to contend for shared-communications medium 302.

At task 1502, station 301-1 transmits a first portion of a flow into shared-communications medium 302, wherein the first portion has a maximum length of T milliseconds. It will be clear to those skilled in the art how to transmit into shared-communications medium 302.

At task 1503, station 301-1 waits at least T*(N−1) milliseconds before again contending for access to shared-communications medium 302 to transmit a second portion of the flow. It will be clear to those skilled in the art how to wait before again contending for shared-communications medium 302.

It is to be understood that the above-described embodiments are merely illustrative of the present invention and that many variations of the above-described embodiments can be devised by those skilled in the art without departing from the scope of the invention. It is therefore intended that such variations be included within the scope of the following claims and their equivalents.

What is claimed is:

1. A method comprising:
contending for access to a shared-communications medium;
transmitting a first portion of a flow into said shared-communications medium, wherein said first portion has a maximum length of T milliseconds; and
waiting for at least T*(N−1) milliseconds before again contending for access to said shared-communications medium to transmit a second portion of said flow, wherein N is a positive integer equal to the number of coordinated flows permitted concurrently on said shared-communications medium.

2. The method of claim 1 further comprising waiting for at least (T+K)*(N−1) milliseconds before again contending for access to said shared-communications medium wherein K is at least equal to the arbitration interframe space in milliseconds.

3. The method of claim 1 further comprising waiting an interval equal to one arbitration interframe space before said transmitting.

4. The method of claim 1 further comprising transmitting, before transmitting said first portion, a frame indicating duration through the end of said first portion.

5. The method of claim 1 wherein at least two coordinated flows originate from the same station.

6. The method of claim 1 wherein at least one of an access point and a hybrid coordinator distributes parameters related to coordinated flows.

7. The method of claim 1 wherein said shared-communications medium constitutes an 802.11 network.

8. The method of claim 1 wherein a station transmits for the second time a data frame constituting said first portion after one point interframe space has elapsed without a response to the first transmission of said data frame.

9. The method of claim 1 further comprising acquiring permission to communicate said first portion by:
transmitting a query; and
receiving, in response to transmitting said query, permission to transmit said first portion.

10. The method of claim 1 further comprising acquiring permission to transmit said first portion by receiving a beacon frame indicating permission.

11. The method of claim 1 further comprising acquiring permission to transmit said first portion by detecting during a search interval less than N coordinated flows to be present on said shared-communications medium.

12. The method of claim 1 further comprising concatenating a plurality of frames into said first portion before said transmitting.

13. The method of claim 1 further comprising:
entering a power save mode during said waiting; and
waking up from said power save mode before contending for access to said shared-communications medium to transmit said second portion.
